(19) United States
(12) Patent Application Publication
(10) Pub. No.: US 2026/0208125 A1
(43) Pub. Date: Jul. 23, 2026

(54) PROCESS OF MANUFACTURING A DEVICE AND DEVICE FOR THE TREATMENT OF FLUIDS

(71) Applicants: MEDICA S.P.A, MEDOLIA (MO) (IT); SETLANCE S.R.L., SIENA (IT)

(72) Inventors: Letizia Bocchi, Medolla (IT); Giuseppe Palumbo, Medolla (IT); Alessandro Pini, Siena (IT); Chiara Falciani, Siena (IT); Luisa Bracci, Siena (IT)

(21) Appl. No.: 19/138,275

(22) PCT Filed: Dec. 11, 2023
(86) PCT No.: PCT/IB2023/062492

§ 371 Date: Jun. 12, 2025

(30) Foreign Application Priority Data
Dec. 12, 2022 (IT) 102022000025365

(51) Int. Cl. B01D 69/14; B01D 67/00; B01D 69/08; B01D 71/68

(52) U.S. Cl. CPC B01D 69/144; B01D 67/00931; B01D 69/08; B01D 71/68; B01D 2221/10; B01D 2257/91; B01D 2257/93; B01D 2323/34; B01D 2323/36; B01D 2323/385; B01D 2325/48

(57) ABSTRACT

Process of manufacturing a device (1) for the treatment of fluids, comprising a combination step, during which a substrate, comprising hollow fibre membranes, is combined with a compound having one or more peptides with sequence KKIRVRLSA (SEQ ID NO. 1) so that a chemical bond with one another is created; the hollow fibre membranes comprise: polysulfone, polyethersulfone, polysulfone with polyvinylpyrrolidone, polyethersulfone with polyvinylpyrrolidone and derivatives thereof; the device (1) is surprisingly capable of removing live bacteria and endotoxins from a biological fluid (e.g. blood plasma).

### CROSS-REFERENCE TO RELATED APPLICATIONS

This Patent Application claims priority from Italian Patent Application No. 102022000025365 filed on Dec. 12, 2022 the entire disclosure of which is incorporated herein by reference.

### TECHNICAL FIELD

The present invention relates to a process of manufacturing a device for the treatment of fluids, to a device for the treatment of fluids and to uses of such a device. The present invention also relates to treated hollow fibre membranes.

### BACKGROUND OF THE INVENTION

Sepsis is a clinical syndrome caused by the body's clotting and immune systems.

Septic shock manifests itself with alterations of the blood circulation and of the cellular metabolism. The supply of oxygen and nutrients to tissues and organs drops, which can go into acute insufficiency.

Sepsis is a major cause of death in people of all ages and in particular its mortality rate is significantly higher than that of other pathologies, such as stroke and heart attack.

Patients affected by sepsis are usually treated with intravenous antibiotics, oxygen, fluids, and medications to stimulate the heart and maintain an acceptable blood pressure level.

Thanks to the early diagnoses and to an increased implementation of best practices, mortality due to sepsis has become less of an immediate fatal disorder and more of a long-term chronic disease, often connected with prolonged inflammation, immune suppression, organ damage, and lean tissue deterioration. In addition, patients who survive sepsis continue to risk mortality as well as long-term cognitive and functional deficits.

Lipopolysaccharide (LPS) is the main constituent of the outer membrane of Gram-negative bacteria and is one of the major responsible for the clinical syndrome of sepsis.

LPS is able to link to a specific host receptor triggering an inflammatory reaction characterized by the release of a large number of inflammatory mediators that allow the host to respond to the pathogen. However, this production can become uncontrolled and excessive, leading to the development of a septic shock.

In addition, lipoteichoic acid (LTA), a major cell wall component of Gram-positive bacteria, is connected with various inflammatory diseases ranging from minor skin conditions to severe sepsis.

WO20100338220 discloses the peptide sequence KKIRVRLSA provided in monomeric, dendrimer and multimeric forms, in particular in the form of the compound of formula (III) (see below), and describes the ability of M33 to neutralize LPS.

Peptide M33 has been identified and characterized by its ability to function as a potent antibacterial. The mechanism of action is based on the chemical-physical characteristics of the peptide. In particular, M33 shows an excess of positive charges thanks to the charged amino acids of which it is composed and this allows it to link with rather high affinities to the bacterial surfaces through interactions with LPS and LTA (of course, negatively charged). The peptide is produced in tetrabranched form wherein 4 identical peptide sequences are linked to a core of lysines.

Recent patent application WO2018193011 proposes to link M33 to an agarose substrate by means of a procedure requiring several relatively complicated and long steps.

Compared to the state of the art, therefore, the need to have alternatives that can potentially be used for the treatment and/or the prevention of sepsis is still felt.

In particular, the need is also felt to identify ways in order to allow that in a simple and inexpensive way the peptide M33 carries out and improves an action of removal of the endotoxins and at the same time (in synergy with other components) removes bacteria.

Aim of the present invention is to provide a process of manufacturing a device for the treatment of fluids, treated hollow fibre membranes, a device for the treatment of fluids and uses of such a device, which allow to overcome, at least partially, the drawbacks of the prior art and are, at the same time, easy and economical to implement.

### SUMMARY

According to the present invention, a process of manufacturing a device for the treatment of fluids, treated hollow fibre membranes, a device for the treatment of fluids and uses of such a device according to what is recited in the independent claims that follow and, preferably, in any one of the claims directly or indirectly dependent on the independent claims are provided.

### BRIEF DESCRIPTION OF THE DRAWINGS

The invention will be hereinafter described with reference to the accompanying drawings, which show some non-limiting embodiment examples thereof, wherein:

FIG. 1 schematically shows a device in accordance with the present invention;

FIG. 2 is a photograph of substrate granules (untreated hollow fibre) usable in a process in accordance with the present invention;

FIGS. 3A, 3B and 3C are SEM images of a substrate (untreated hollow fibre) usable in a process in accordance with the present invention;

FIG. 4 shows an SEM image of a cross section of the material of FIG. 2;

FIG. 5 shows formula (III) reported in extended mode; and

FIG. 6 shows the chromatograms (the abscissa reports the time in minutes; the ordinate arbitrary units in mV) made on washing liquids passed through a device in accordance with the present invention (chromatogram with dotted line) and a device containing hollow fibre membranes simply combined (without beta irradiation) with the compound with formula (III);

FIG. 7 is a graph showing the results obtained in comparison tests between a device in accordance with the present invention and another device (the abscissa reports the time in minutes; the ordinate reports the CFUs—Colony Forming Unit/ml);

FIG. 8 is a graph showing the results obtained in comparison tests between a device in accordance with the present invention and another device (the abscissa reports the time in minutes; the ordinate reports the EU/mL of endotoxin—EU: endotoxin units); and

FIG. 9 shows the sampling positions of some of the tests performed.

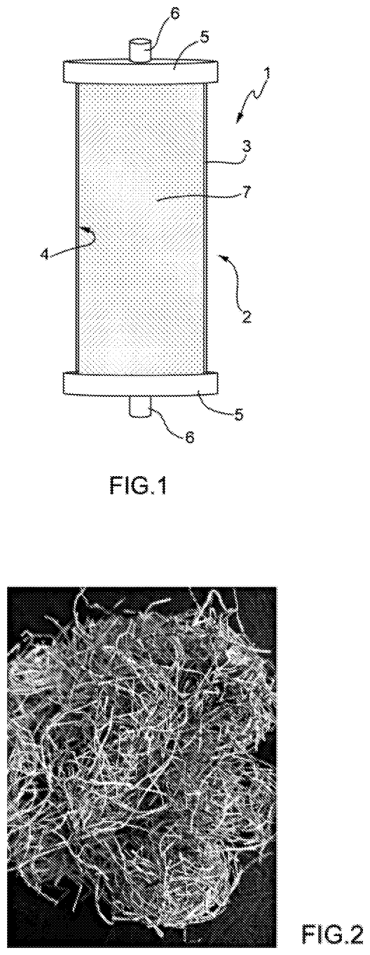

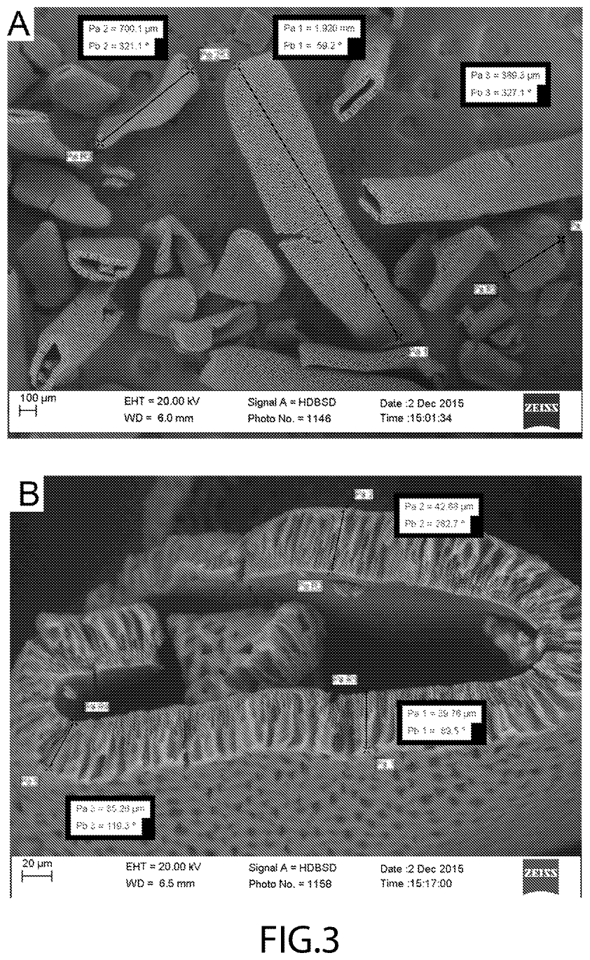

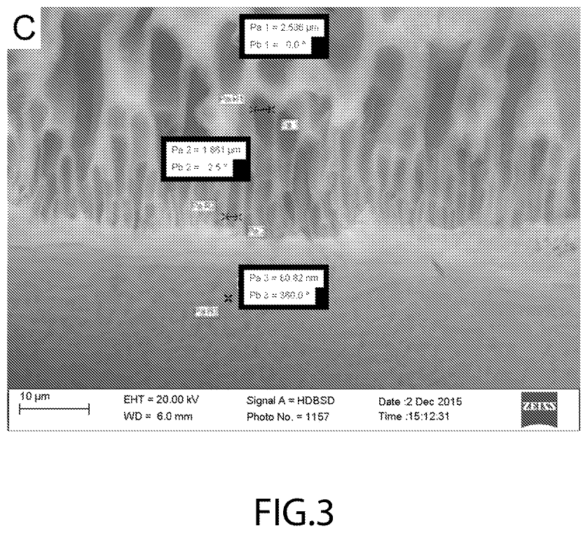

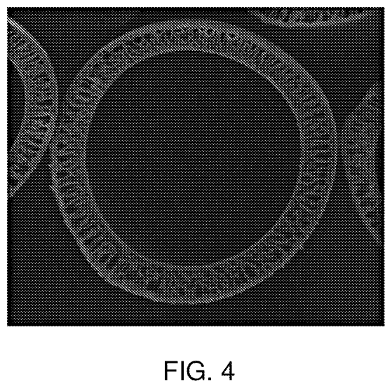

### DETAILED DESCRIPTION

In FIG. 1, 1 denotes as a whole a device for the treatment of fluids, which device 1 comprises treated hollow fibre membranes 7.

In particular, the device 1 comprises a cartridge 2, in turn provided with a side wall 3 (typically cylindrical in shape), which is adapted to define an adsorption chamber 4. In particular, the cartridge 2 further comprises a pair of circular closing elements 5 arranged to close the axial ends of the side wall 3. In each one of the circular closing elements 5 an opening is obtained to allow the entry and the outflow of the liquid to be treated. Each one of the circular closing elements 5 comprises a fitting 6 at the respective opening for the connection of treatment tubes. Generally, the cartridge 2 is made of plastic material, such as for example polycarbonate.

In addition or alternatively openings for the entry and the outflow of the liquid to be treated can also be made on the side surface of the cartridge.

In accordance with a first aspect of the present invention, a process of manufacturing the device 1 is provided.

The process comprises: a combination step, during which a substrate, comprising hollow fibre membranes (in particular, consisting of hollow fibre membranes), is combined with at least one compound (with a formula) having at least one peptide with sequence KKIRVRLSA (SEQ ID NO. 1) so that the at least one compound becomes chemically (in particular, covalently) linked to the substrate (to the hollow fibre membranes) and the treated hollow fibre membranes 7 are obtained (consequently). The hollow fibre membranes comprise (are made of) a base material (in particular, a polymer) chosen from the group consisting of: polysulfone, polyethersulfone, polysulfone with polyvinylpyrrolidone, polyethersulfone with polyvinylpyrrolidone (and derivatives thereof). In particular, the hollow fibre membranes comprise (are made of) a base material (in particular, a polymer) chosen from the group consisting of: polyethersulfone, polyethersulfone with polyvinylpyrrolidone (and derivatives thereof). In some specific and non-limiting cases, the base material is polyethersulfone (in particular, with polyvinylpyrrolidone).

Each amino acid of the aforementioned peptide has, independently of the other ones, L or D configuration.

The process described above allows to obtain treated hollow fibre membranes 7 (and devices for the treatment of fluids containing them) in an industrial manner (and quantity), in a simple and fast way. It has been experimentally observed that the device thus obtained is surprisingly able to reduce (in particular, remove) endotoxins (derived from Gram-negative bacteria), lipoteichocic acids (derived from Gram-positive bacteria) and at the same time bacteria from liquids (in particular, organic liquids such as e.g. plasma and blood).

During the combination step, the substrate comes into contact with said compound so as to obtain a mixture of the substrate and of the compound; during the combination step, the mixture is treated with (subjected to) radiations (in particular, ionizing radiations; in particular, corpuscolar radiations), in particular so that the at least one compound becomes covalently linked to the hollow fibre membranes (in particular, to the base material) and the treated hollow fibre membranes 7 are obtained. For example, such radiations are beta and/or gamma radiations (in particular, beta radiations).

It has been experimentally observed that by treating the mixture in accordance with the present invention it is surprisingly possible to obtain a chemical (more precisely, covalent) bond between the compound and the substrate (between the hollow fibre membranes and the compound; in particular, between the base material and the compound) in a simple and fast way. In this regard, it should be noted that, in this way, laborious and long steps of protecting functional groups and/or of reactions under controlled conditions and/or the use of linkers and/or other particular reagents and/or stresses (e.g. thermal ones, of UV pH etc.) are not necessary. It should also be noted that the production timings are in particular reduced in view of the fact that the coupling between substrate and compound takes place at the same time as the sterilization of the material (beta radiations also allows to sterilize material for medical use in addition to causing the bond between substrate and compound).

According to some non-limiting embodiments, during the combination step, the substrate and the compound come into contact with one another inside the cartridge 2 (in particular, sealed; more in particular, the openings of which are sealed). In particular, during the combination step, the cartridge containing said mixture is treated with the aforementioned radiations (in particular, ionizing radiations; in particular, corpuscolar radiations), for example beta and/or gamma radiations (in particular, beta radiations).

This speeds up and simplifies the handling of the material, which is treated (therefore also sterilized) all together and at the same time.

Advantageously but not necessarily, the mixture is treated with an amount of beta radiations smaller than 150 KGy (in particular, smaller than 50 KGy). More advantageously but not necessarily, during the combination step, the mixture is treated with an amount of beta radiations smaller than 30 KGy (in particular, equal to or smaller than 28 KGy; more in particular, equal to or smaller than 25 KGy). In particular, the mixture is treated with an amount of beta radiations greater than 5 KGy (in particular, greater than 10 KGy).

The amount of radiation is measured (during amount mapping tests) in accordance with IS011137-1:2020 standard, in particular, by means of thin film dosimeters (FWT, Far West Technology). Reference dosimeters are routinely used.

By keeping the provided quantity of radiations relatively low, the risk of damaging the compound, the substrate and, when present, the cartridge 2 can be reduced.

According to some non-limiting embodiments, during the combination step, a liquid (in particular, a solution), containing the aforementioned compound, comes into contact with the substrate (so as to obtain the mixture). In particular, the liquid is inserted into the cartridge 2, in which, more in particular, the substrate is located.

Advantageously but not necessarily, the liquid is an aqueous solution (for example a 0.9 wt % NaCl saline solution or a PBS—a phosphate-buffered saline). According to some non-limiting embodiments, the solution is composed of at least circa 95% by weight of water.

Advantageously but not necessarily, the liquid (the solution) has a concentration of the compound up to circa 5 mg/mL (in particular, up to circa 3 mg/mL; preferably lower than circa 2 mg/mL).

According to some non-limiting embodiments, the liquid (the solution) has a concentration of the compound of at least circa 0.3 mg/mL (preferably, of at least circa 0.5 mg/mL).

For example, the liquid (the solution) has a concentration of the compound ranging from circa 1 mg/mL to circa 2 mg/mL (in particular, from circa 0.5 mg/mL to circa 1.5 mg/mL).

Advantageously but not necessarily, the compound has (a formula with) at least two (in particular, four) of the aforementioned peptides with sequence KKIRVRLSA (SEQ ID NO. 1).

According to some preferred but non-limiting embodiments, the compound has a formula chosen from the group consisting of (I) and (II):

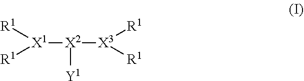

wherein each R¹ represents the aforementioned peptide; X¹, X² and X³ are the same or different from one another and represent, each one independently of the other ones, an at least bifunctional radical (in particular having at least two amino groups; in particular, an amino acid; more in particular, a lysine); Y¹ is for example chosen from —H, a further amino acid (in particular, -beta-alanine or -cysteine; more in particular, -beta-alanine) and a further peptide;

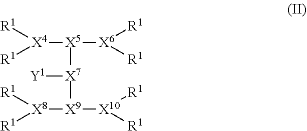

wherein each R¹ represents the aforementioned peptide; X¹, X², X³, X⁴, X⁵, X⁶, X⁷, X⁸, X⁹ and X¹⁰ are the same or different from one another and represent, each one independently of the other ones, an at least bifunctional radical (in particular having at least two amino groups; in particular, an amino acid; more in particular, a lysine); Y¹ is for example chosen from —H, a further amino acid (in particular, -beta-alanine or -cysteine; more in particular, -beta-alanine) and a further peptide (in particular, -beta-alanine and -cysteine).

Alternatively or in addition, Y¹ is chosen from —H and an organic radical (with or without functional groups).

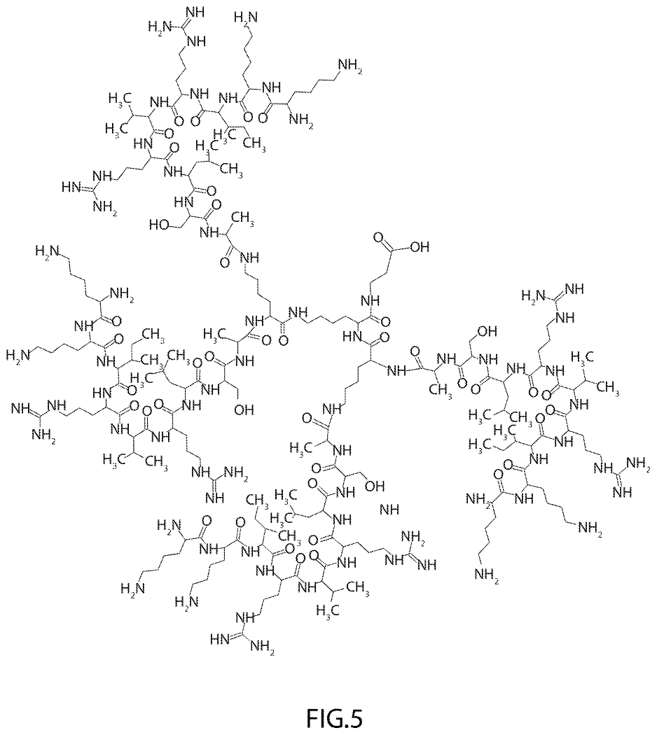

According to some specific and non-limiting embodiments, the compound has formula (III):

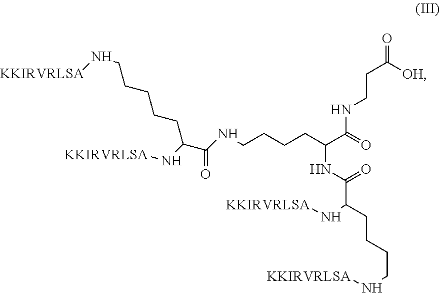

wherein, as per usual standardization, K denotes lysine; I denotes isoleucine; R denotes arginine; V denotes valine; L denotes leucine; S denotes serine; A denotes alanine. FIG. 5 reports formula (III) in extended form.

The compound can be synthesized following the methodologies known in the technical field and, more precisely, as described within WO20100338220 and the European patents EP2344178B1 (see, in particular, paragraph [0020]), and EP2595496B1 (see, in particular, paragraphs [0017] and [0018]) and the articles: Pini, A., Falciani, C., Mantengoli, E., Bindi, S., Brunetti, J., Iozzi, S., Rossolini, G. M. & Bracci L. A novel tetrabranched antimicrobial peptide that neutralizes bacterial lipopolysaccharide and prevents septic shock in vivo. FASEB J. 24, 1-8 (2010); Brunetti, J., Falciani, C., Roscia, G., Pollini, S., Bindi, S., Scali, S., Arrieta, U. C., Gómez-Vallejo, V., Quercini, L., Ibba, E., Prato, M., Rossolini, G. M., Llop, J., Bracci, L. & Pini, A. In vitro and in vivo efficacy, toxicity, bio-distribution and resistance selection of a novel antibacterial drug candidate. Sci. Rep. 6, 26077 (2016); Cresti L, Falciani C, Cappello G, Brunetti J, Vailati S, Melloni E, Bracci L, Pini A. Safety evaluations of a synthetic antimicrobial peptide administered intravenously in rats and dogs. Sci Rep. 2022 Nov. 11; 12(1):19294. doi: 10.1038/s41598-022-23841-2.

According to some non-limiting embodiments, the hollow fibre membranes are porous, in particular for filtration (more in particular, for micro- or ultrafiltration).

In some non-limiting cases, the hollow fibre membranes have a plurality of conjugated (delocalized) n-systems. In particular, the hollow fibre membranes have a plurality of aromatic groups (in other words, in these cases, the conjugated n-systems are aromatic groups).

In particular, each one of the hollow fibre membranes has a side wall, comprising the (consisting of the) base material, and an inner cavity, which is delimited by the side wall.

According to some non-limiting embodiments, the side wall has a thickness ranging from circa 25 μm (in particular, from circa 40 μm) to circa 400 μm (in particular, to circa 150 μm). In some cases, the side wall has a thickness up to circa 90 μm (in particular, up to circa 85 μm).

In particular, the side wall has an outer surface provided with pores with a diameter ranging from circa 0.1 μm to circa 15 μm and an inner surface provided with pores with a diameter ranging from circa 5 nm to circa 200 nm.

According to some non-limiting embodiments, the hollow fibre membranes have a length ranging from circa 0.1 mm to circa 50 mm (in particular, to circa 30 mm; more in particular, to circa 5 mm).

The length measurement of the hollow fibre membranes is obtained by successive sieving with sieves with holes having decreasing dimensions. The diameter of the holes of the first sieve that does not allow the particles to pass indicates the dimensions (i.e. diameter) of the particles.

In particular, the hollow fibre membranes have an average length ranging from circa 0.1 mm to circa 50 mm (in particular, to circa 30 mm; more in particular, to circa 5 mm).

Unless the contrary is explicitly specified, in the present text, the average length is identified by measuring (e.g. by means of an optical microscope) the length of fifty randomly chosen hollow fibre membranes. More in general, in this text the average measurements are calculated by averaging fifty random measurements.

The diameter of the pores is measured by SEM. More precisely, the dimension is measured in one direction (taken randomly).

According to some non-limiting embodiments, the pores of the outer surface have an average diameter ranging from circa 0.1 μm to circa 15 μm. In addition or alternatively, the pores of the inner surface have pores with an average diameter ranging from circa 5 nm to circa 200 nm.

Unless the contrary is explicitly specified, in this text, the average diameter of the pores is measured by SEM. More precisely, the calculation of the average diameter is performed by measuring the dimension in a single direction (taken randomly) of fifty pores (taken randomly) and by averaging. In particular, a SEM instrument is used.

According to some non-limiting embodiments, the inner cavity has a cross section with an area ranging from circa 5000 μm² to circa 200000 μm².

In particular, the inner cavity has an inner (more in particular, average) diameter up to circa 1000 μm (more in particular, up to circa 900 μm; even more in particular, up to circa 400 μm). According to some non-limiting embodiments, the inner cavity has an inner (more in particular, average) diameter of at least 10 μm (in particular, of at least 100 μm).

Advantageously but not necessarily, the hollow fibre membranes have a cut off up to circa 1500 kDalton (in particular, up to 1000 kDalton).

According to some embodiments, the hollow fibre membranes have a cut-off ranging from (at least) circa 10 (more precisely, from 14) KDalton. Cut-off refers to the molecular weight of the species (polymers, bacteria, viruses, etc.) that are 90% retained by the membrane.

The cut-offs are determined (in particular, indirectly) by performing retention (filtration) tests with molecules having known (and decreasing) molecular weight.

In particular, the molecules in question are proteins or dextrans conjugated to fluorescent (fluorolabelled dextrans) or stained markers. Typically, the fluorolabelled dextrans are used. Briefly, a solution containing one or more molecules with known molecular weight (MW) is created, which is filtered through the membrane. If the detection technique allows it, it is possible to use a solution with several molecules having known MW (molecular weight) to be filtered simultaneously. The concentration may vary depending on the dimension and on the number of fibres in the device. When albumin is used, the concentration is 35-40 mg/ml, like the physiological one. If fluorolabelled dextrans are used, the concentration used is circa 20 mg/ml. The fluorolabelled dextrans are at MWs of 4, 70, 150, and 2000 kDa.

The concentration of the molecules with known MW is detected (for tangential filtration) at the inlet, at the outlet to the filter and in the filtrate. Various techniques are available for measuring the concentration depending on the protein/dextran and on any conjugation. For example, it can be detected by spectrophotometric, immunoenzymatic, fluorometric, electrophoretic, chromatographic techniques. The cut-off of the filter corresponds to the lowest molecular weight of the molecule that is retained by the membrane with a sieving coefficient of at least 9.0. For tangential filtration the sieving coefficient is calculated as follows: [2× concentration of the filtrate]/[input concentration+output concentration].

Similarly, also the treated hollow fibre membranes 7 comprise a side wall and an inner cavity, which is delimited by the side wall having characteristics and dimensions such as those indicated above for the hollow fibre membranes. In other words, the treated hollow fibre membranes 7 are substantially identical to the hollow fibre membranes and differ from them only in that they have (have linked) the aforementioned compound (on their surface). The characteristics described for the hollow fibre membranes are therefore also to be taken into consideration for the treated hollow fibre membranes 7.

In particular, the hollow fibre membranes are like and/or can be prepared as described (with any appropriate adjustments) in the patent application with publication number EP2316560A1 and/or EP3208241A1. The hollow fibre membranes of this type are also marketed by Medica spa (Via Degli Artigiani, 7, 41036 Medolla MO, Italy) under the name of Medisulfone® and Versatile-PES©.

Note that it has been experimentally observed that, the hollow fibre membranes (whether treated or not) clog surprisingly very little.

In accordance with a second aspect of the present invention, the treated hollow fibre membranes 7 are provided as described above (with reference to the first aspect of the present invention).

In accordance with a third aspect of the present invention, the treated hollow fibre membranes 7 (as described above) for the treatment (and/or the prevention) of sepsis are provided.

In accordance with a fourth aspect of the present invention, a method of treatment (and/or of prevention) of sepsis using the treated hollow fibre membranes 7 (as described above) is provided. In some specific non-limiting cases, this method uses the device 1 (as described above).

In accordance with a fifth aspect of the present invention, the device for the treatment of fluids 1 is provided. In particular, the device 1 is as defined above. More in particular, the compound and the treated hollow fibre membranes 7 are as above described and/or defined.

According to some non-limiting embodiments, the device 1 is obtained (obtainable) by the process referred to in the first aspect of the present invention.

In accordance with a sixth aspect of the present invention, an (ex-vivo) use of the device 1 for the (at least partial) removal of live bacteria and endotoxins from a (in particular, biological) fluid is provided. In particular, the fluid is a liquid and, for example, may be blood or blood plasma. In some specific and non-limiting cases, it is blood plasma.

In particular, the use provides for feeding the fluid through the device 1.

A method for the (at least partial) (ex-vivo) removal of live bacteria and endotoxins from a (in particular, biological) fluid is also provided. In particular, the fluid is a liquid and, for example, may be blood or blood plasma. In some specific and non-limiting cases, it is blood plasma.

In particular, the use provides for feeding the fluid through the device 1.

Unless the contrary is explicitly specified, the content of the references (articles, books, patent applications, etc.) cited in this text is herein fully recalled. In particular, the mentioned references are herein incorporated by reference.

Further characteristics of the present invention will become apparent from the following description of a merely illustrative and non-limiting example.

### Example 1

This example describes the realization of an embodiment of devices 1 in accordance with the present invention.

The compound with formula (III) was used without modifications (e.g. cysteination or insertion of other linkers).

The compound with formula (III) was solubilized in a saline solution (0.9% NaCl or PBS) at the concentration of 1 mg/ml.

Cartridges 2 containing the base material/substrate (porous granules of PES—Versatile-PES®) were produced. The cartridges were washed with disposable saline solution (note that PBS could also be used).

A saline solution (0.9% NaCl—PBS could also have been used) containing the compound with formula (III) (for some tests with a concentration of 1 mg/ml, for other ones with a concentration of 2 mg/ml—see below Table 1) was loaded into the cartridges 2 in a clean room production environment, by pump (a syringe could also be used). The loaded volume was equal to the filling volume of the cartridges (circa 5 ml), so as to completely fill the device with the solution containing the compound with formula (III). More precisely, in this way, each cartridge 2 contained 0.8 g of substrate and 5 ml of solution).

The device was closed with seal caps and sealed in the packaging. The device was sent to the sterilization workshop where it was subjected to beta irradiation. From the compound loading step to the sterilization step, a time varying from a few days up to circa 15 days may elapse. 1 to 10 days may still elapse from sterilization to the return of the sterile product. In this time the device 1 has travelled at room temperature (uncontrolled) and is stored in cartons.

Tests with irradiations with 13.3 kGy and tests with 25 kGy were carried out, in both cases with two laps on the conveyor belt (different orientation of the carton from one lap to the other one).

In both cases, a washing of the devices 1 was performed with saline solution to remove the excess unlinked peptide. After the initial washing (priming), during which part of the unlinked excess compound (III) was removed, the device was stable and no release of compound (III) was observed in the subsequent steps.

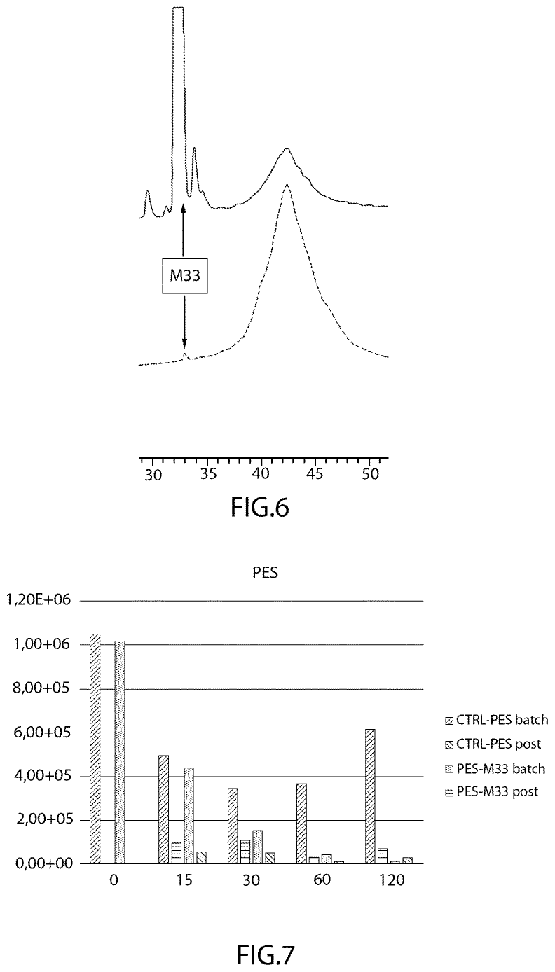

These observations are corroborated by experiments performed in reversed phase chromatography in HPLC and Mass Spectrometry. In particular, the HPLC tests highlighted a marked difference in the compound (III—M33) present in the washing liquid, and therefore not attached to the substrate, between two devices, one subjected to beta irradiation and the other one not irradiated. In the NON-irradiated device (black-coloured curve in the figure below) a peak is evident at circa 32 minutes (light blue arrow), corresponding to the retention time of the compound (III—M33), which even goes beyond the measurement scale of the instrument. The same peak at 32 minutes is present in the (dashed) curve of the device subjected to irradiation but with much smaller dimensions (see FIG. 6, wherein the abscissa axis indicates the minutes of retention inside the chromatographic column and the ordinate arbitrary units in mV). The other peaks are not referable to the peptide or to truncated or aggregated forms thereof, but are probably attributable to products of the substrate which are present in the cartridge.

The results obtained show that in the device subjected to beta irradiation the compound (III) has become covalently linked to the hollow fibre membranes.

### Example 2

This example describes tests performed on devices 1 obtained as described in example 1.

The tests were carried out in dynamic mode (recirculation) and in static mode (static contact) and the removal of bacteria and/or endotoxins and/or lipoteichoic acids from a specially created solution (challenge solution) was evaluated.

The dynamic recirculation conditions employed a flow of 10 ml/min with collection of samples at various time intervals over 2 hours.

The devices tested during the project are summarized in Table 1 below.

TABLE 1

| | Substrate | Conc. | Beta |
|---|---|---|---|
| Substrate | mass | M33 | irradiation |
| material | (gr) | (mg/ml) | (kGy) |
| PES | 0.8 | 2 | 25 |
| PES | 0.8 | 1 | 13.3 |
| CTRL PES | 0.8 | 0 | 25 |

Conc. M33 indicates the concentration of the compound (III) in the solution that has been loaded into the cartridges 2 (see example 1 reported above).

The device 1 (PES-M33) was compared with the relative control (CTRL-PES) not containing the compound (III) in order to demonstrate the activity of the device 1. The bacterial challenge solution is represented by B. diminuta in Saline Lactose Broth at the concentration of 10⁵-10⁶ CFU/ml. The number of CFUs was detected in the samples collected both from the challenge solution (batch) and from the post-cartridge recirculation line (post). The analysis of the sample provides for the dilution and incubation thereof on a culture plate TSA (Tryptone Soy Agar) at 32.5° for 48 hours followed by colony counting.

The results are represented in Table 2 and in the graph referred to in FIG. 7.

The number of CFUs was averaged between the counts performed on plates with different initial dilution of the sample.

TABLE 2

| | |
|---|---|
| CTRL-PES | PES-M33 |

| Time | CFU/ml | CFU/ml | CFU/ml | CFU/ml |
|---|---|---|---|---|
| (min) | batch | post | batch | post |
| 0 | 1.05E+06 | | 1.02E+06 | |
| 15 | 4.95E+05 | 1.00E+05 | 4.40E+05 | 5.65E+04 |
| 30 | 3.45E+05 | 1.10E+05 | 1.53E+05 | 5.20E+04 |
| 60 | 3.67E+05 | 3.00E+04 | 4.25E+04 | 1.00E+04 |
| 120 | 6.15E+05 | 7.00E+04 | 1.25E+04 | 3.00E+04 |

In practice, in FIG. 7: the concentration in CFU/ml of B. diminuta in the recirculating solution at the various treatment times for the control cartridge; CTRL-PES post indicates the identified post-cartridge solution at the various treatment times for the control cartridge; PES-M33 batch indicates the recirculating solution at the various treatment times for the cartridge containing peptide M33; PES-M33 indicates the identified post-cartridge solution at the various treatment times for the cartridge containing peptide M33; and PES-M33 batch indicates the solution at the post-cartridge collection point at the various treatment times for the cartridge containing peptide M33.

FIG. 9 shows where the solutions are sampled. The samples of the solutions identified as “batch” are collected in position B. The samples identified as “post” are collected in position P.

The devices PES-M33 and also CTRL-PES had a marked reduction in the number of CFUs of B. diminuta. This demonstrates that the PES itself has an activity of retention towards bacteria, as demonstrated by the performance of the CTRL-PES. This activity seems quite non-specific since the devices CTRL-PES show a reduction at each passage through the cartridge (post samplings) but this reduction over time is not reflected on the recirculating batch solution, indicating that there is probably a non-specific adsorption and release with different kinetics. However, the most significant result is obtained on the device PES-M33 where the bactericidal activity is significant and also specific since during the 2 hours of treatment a reduction in the number of CFU/ml is obtained, which is reflected on the entire recirculating solution (batch) and which corresponds to 98.8% abatement of the initial B. diminuta concentration of CFUs.

Subsequently, the efficacy of endotoxin removal by devices (cartridges) containing PES-M33 and reference devices (CTRL-PES) was also tested.

Endotoxin removal was quantified by creating a spike solution consisting of LPS at a concentration of 5000 EU/ml in water. A volume equal to 200 ml of spike solution was recirculated through the prototype device PES-M33 and through the control CTRL-PES. Samples were collected both from the recirculating solution (batch) and from the post-cartridge line (post) whose endotoxin concentration was measured by LAL test with chromogenic kinetic method, MCS Nexgen instrument (Charles River).

The quantification allowed to calculate the logarithmic abatement (LRV) of the endotoxin concentration, which is equal to 0 for CTRL-PES and equal to 3 LRV for PES-M33.

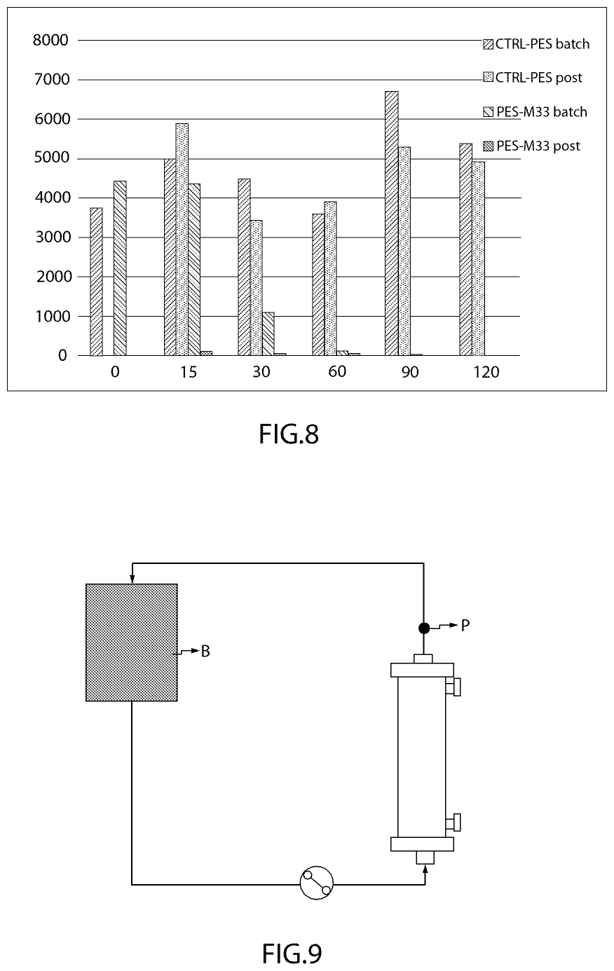

The results obtained are reported in Table 3 and in the graph referred to in FIG. 8.

TABLE 3

Concentration

| | EU/ml | EU/ml | EU/ml | EU/ml |
|---|---|---|---|---|
| Time | CTRL-PES | CTRL-PES | LRV | LRV |
| (min) | batch | post | IN | TOT |
| 0 | 3752 | | | |
| 15 | 5014 | 5900 | | |
| 30 | 4501 | 3449 | | |
| 60 | 3599 | 3915 | | |
| 90 | 6715 | 5301 | | |
| 120 | 5388 | 4936 | −0.03 | 0.01 |
| Time | PES-M33 | PES-M33 | LRV | LRV |
| (min) | batch | post | IN | TOT |
| 0 | 4433 | | | |
| 15 | 4368 | 117 | | |
| 30 | 1103 | 63.5 | | |
| 60 | 125 | 60 | | |
| 90 | 21.6 | 5.73 | | |
| 120 | 4.89 | 3.87 | 2.95 | 3.05 |

In practice, in FIG. 8: CTRL-PES batch indicates the concentration in CFU/ml of B. diminuta in the recirculating solution at the various treatment times for the control cartridge; CTRL-PES post indicates the identified post-cartridge solution at the various treatment times for the control cartridge; PES-M33 batch indicates the recirculating solution at the various treatment times for the cartridge containing peptide M33; PES-M33 indicates the identified post-cartridge solution at the various treatment times for the cartridge containing peptide M33; and PES-M33 batch indicates the solution at the post-cartridge collection point at the various treatment times for the cartridge containing peptide M33.

FIG. 9 shows where the solutions are sampled. The samples of the solutions identified as “batch” are collected in position B. The samples identified as “post” are collected in position P.

1. A process of manufacturing a device (1) for the treatment of fluids; the device (1) comprises treated hollow fiber membranes (7);
the process comprises:
a combination step, during which a substrate, comprising hollow fiber membranes, is combined with at least one compound having at least one peptide with sequence KKIRVRLSA (SEQ ID NO. 1) so that said at least one compound becomes covalently linked to the substrate and the treated hollow fiber membranes (7) are obtained;
the hollow fiber membranes comprising a base material chosen from the group consisting of: polyethersulfone, polyethersulfone with polyvinylpyrrolidone and derivatives thereof;
during the combination step, said substrate comes into contact with said compound so as to obtain a mixture of the substrate and of the compound; during the combination step, said mixture is treated with ionizing radiations so that the at least one compound becomes covalently linked to the hollow fiber membranes and the treated hollow fiber membranes are obtained (7);
each one of the amino acids of said peptide having, independently of the other ones, L or D configuration.

2. The process according to claim 1, wherein, during the combination step, said mixture is treated with beta and/or gamma radiations.

3. The process according to claim 2, wherein, during the combination step, said mixture is treated with an amount smaller than 50 KGy of the beta and/or gamma radiations.

4. The process according to claim 2, wherein, during the combination step, the substrate and the compound come into contact with one another inside a cartridge; during the combination step, the cartridge containing said mixture is treated with the beta and/or gamma radiations.

5. The process according to claim 1, wherein, during the combination step, a liquid containing said compound comes into contact with said substrate; in particular, the liquid is inserted into said cartridge, in which, more in particular, the substrate is located.

6. The process according to claim 1, wherein the compound has at least two said peptides with sequence KKIRVRLSA (SEQ ID NO. 1).

7. The process according to claim 1, wherein said compound has a formula chosen from the group consisting of (I) and (II): 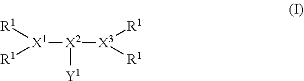
wherein each R¹ represents said peptide; X¹, X² and X³ are the same or different from one another and represent, each one independently of the other ones, an at least bifunctional radical (in particular, an amino acid); Y¹ is chosen from —H, a further amino acid (in particular, -beta-alanine or -cysteine) and a further peptide; 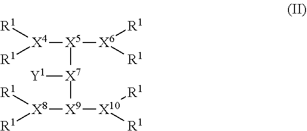
wherein each R¹ represents said peptide; X¹, X², X³, X⁴, X⁵, X⁶, X⁷, X⁸, X⁹ and X¹⁰ are the same or different from one another and represent, each one independently of the other ones, an at least bifunctional radical; Y¹ is chosen from —H, a further amino acid and a further peptide.

8. The process according to claim 1, wherein each one of the hollow fibre membranes has a side wall, comprising a base material, and an inner cavity, which is delimited by the side wall; the side wall has a thickness ranging from circa 25 μm to circa 150 μm as well as an outer surface provided with pores with a diameter ranging from circa 0.1 μm to circa 15 μm and an inner surface provided with pores with a diameter ranging from circa 5 nm to circa 200 nm; the inner cavity has a cross section with an area ranging from circa 5000 μm² to circa 200000 μm²;
the hollow fiber membranes are granules with a length ranging from circa 0.1 mm to circa 50 mm.

9. The process according to claim 1, wherein said compound has formula (III):

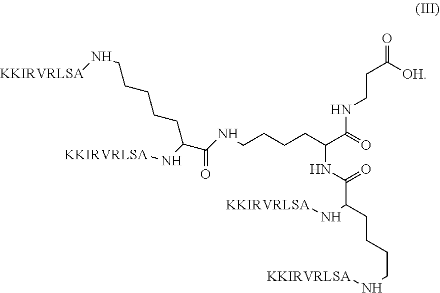

10. The process according to claim 1, wherein during the combination step, said mixture is treated with beta radiations.

11. A device for the treatment of fluids; the device (1) comprises treated hollow fiber membranes (7), which comprise a base material chosen from the group consisting of: polyethersulfone, polyethersulfone with polyvinylpyrrolidone and derivatives thereof;
the treated hollow fiber membranes (7) further comprise a compound having at least one peptide with sequence KKIRVRLSA (SEQ ID NO. 1) covalently linked to the base material;
each one of the amino acids of said peptide having, independently of the other ones, L or D configuration.

12. The device according to claim 11 and comprising a cartridge provided with at least an inlet and an outlet and containing said treated hollow fiber membranes (7);
the treated hollow fiber membranes are granules with a length ranging from circa 0.1 mm to circa 50 mm;
the compound has at least two peptides with sequence KKIRVRLSA (SEQ ID NO. 1).

13. The device according to claim 11, wherein said compound has a formula chosen from the group consisting of (I) and (II): 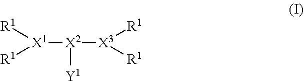
wherein each R¹ represents said peptide; X¹, X² and X³ are the same or different from one another and represent, each one independently of the other ones, an at least bifunctional radical; Y1 is chosen from —H, a further amino acid and a further peptide; and 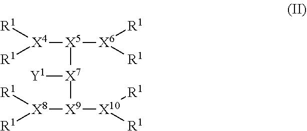
wherein each R¹ represents said peptide; X¹, X², X³, X⁴, X⁵, X⁶, X⁷, X⁸, X⁹ and X¹⁰ are the same or different from one another and represent, each one independently of the other ones, an at least bifunctional radical; Y1 is chosen from —H, a further amino acid and a further peptide.

14. The device according to claim 11, wherein each one of the hollow fiber membranes has a side wall, comprising a base material, and an inner cavity, which is delimited by the side wall; in particular, the side wall has a thickness ranging from circa 25 μm to circa 150 μm said compound has formula (III):

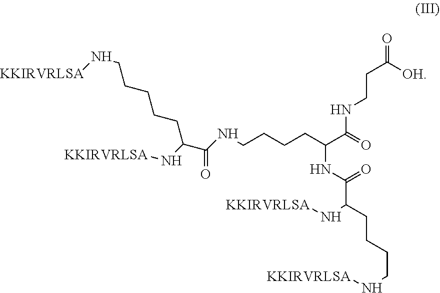

15. A use of the device (1) of claim 11 for the at least partial removal of live bacteria and endotoxins from a fluid; the use provides for feeding the fluid through the device (1).

16. Treated hollow fiber membranes; the treated hollow fiber membranes (7) comprise a base material chosen from the group consisting of: polyethersulfone, polyethersulfone with polyvinylpyrrolidone and derivatives thereof;
the treated hollow fibre membranes (7) further comprise a compound having at least one peptide with sequence KKIRVRLSA (SEQ ID NO. 1) covalently linked to the base material;
each one of the amino acids of said peptide having, independently of the other ones, L or D configuration.


SEQUENCE LISTING (1 sequence)

SEQ ID NO: 1 - protein, 9 aa, synthetic construct
KKIRVRLSA